(19) United States
(12) Patent Application Publication
(10) Pub. No.: US 2011/0269021 A1
(43) Pub. Date: Nov. 3, 2011

(54) LITHIUM ION BATTERY

(76) Inventors: Cheng-Hua FU, Dongguan (CN); Rui Xu, Dongguang (CN); Chang-Long Han, Dongguang (CN)

(21) Appl. No.: 12/768,732

(22) Filed: Apr. 28, 2010

(51) Int. Cl. H01M 4/52

(52) U.S. Cl. 429/221

(57) ABSTRACT

A lithium ion battery includes a negative electrode, a positive electrode, an separator between the electrodes, and electrolyte for submerging the electrodes. The negative electrode is made of active materials including at least one lowly graphitized carbon material and least one highly graphitized carbon material. The positive electrode made of active materials including lithium ion, transition metal ion and polyanion. The polyanion is selected from the group consisting of phosphate, silicate, sulfate and hydrofluoric acid. The transition metal ion is selected from the group consisting of the divalent ions of iron and manganese.

### BACKGROUND OF INVENTION

1. Field of Invention

The present invention relates to a lithium ion battery and, more particularly, to a lithium ion battery with which the discharge of depth (DOD) can precisely be determined by the discharge voltage.

2.Related Prior Art

Electric vehicles (EV) are getting more and more attention as the environmental issue is getting more and more attention. An electric vehicle uses energy stored in a rechargeable battery instead of fossil fuel to reduce emission. Lithium iron phosphate (LiFePO₄) is abundant, inexpensive and high safe, which make it one of the major positive electrode materials of Lithium ion battery for electric vehicles (EV) and plug-in hybrid electric vehicles (PHEV). And the main negative electrode material of Lithium ion battery for EV and HEV is graphite, which exhibits a high energy density and is inexpensive.

The positive electrode made of LiFePO₄ exhibits a flat discharge curve, and so does the negative electrode made of graphite. The rechargeable battery with positive electrode made of LiFePO₄ and negative electrode made of graphite hence exhibits a flat discharge curve, and it is difficult to indicate the DOD of the battery by the discharge voltage. Precise indication of the DOD is important for efficient management of the rechargeable battery. This problem does not only bother a positive electrode made of LiFePO₄ and negative electrode made of graphite but also bothers a battery with positive electrode made of other polyanionic materials such as lithium manganese phosphate (LiMnPO₄), lithium iron silicate (Li₂FeSiO₄) and etc, and negative electrode made of other highly graphitized carbon materials such as mesophase micro-bead (MCMB), mesophase carbon fiber (MCF) and etc.

Lowly graphitized carbon materials such as soft carbon and hard carbon exhibit inclined discharge curves. Hence, a negative electrode made of such a lowly graphitized carbon material makes a rechargeable battery exhibit an inclined discharge curve to facilitate the indication of the DOD by the discharge voltage. However, such a negative electrode exhibits a low specific capacity, a low initial coulombic efficiency, a low electrode density, and a low average cell voltage. Therefore, such a rechargeable battery exhibits a low energy density.

The present invention is therefore intended to obviate or at least alleviate the problems encountered in prior art.

### SUMMARY OF INVENTION

The primary objective of the present invention is to provide a lithium ion battery with which the DOD can be precisely indicated by the discharge voltage.

To achieve the foregoing objective, the lithium ion battery includes a negative electrode, a positive electrode, a separator between the electrodes, and electrolyte. The negative electrode is made of active materials including at least one lowly graphitized carbon material and at least one highly graphitized carbon material. The positive electrode made of active materials including lithium ion, transition metal ion and polyanion. The polyanion is selected from the group consisting of phosphate, silicate, sulfate and fluorosulfate. The transition metal ion is selected from the group consisting of the divalent ions of iron and manganese.

In an aspect, the lowly graphitized carbon material is selected from the group consisting of hard carbon, soft carbon and their combinations, wherein the highly graphitized material is selected from the group consisting of graphite, MCMB, MCF and their combinations.

Preferably, the weight ratio of the lowly graphitized material to the highly graphitized material is 1:9 to 8:2.

More preferably, the weight ratio of the lowly graphitized material to the highly graphitized material is 1:9 to 5:5.

More preferably, the weight ratio of the lowly graphitized material to the highly graphitized material is 1:9 to 3:7.

Most preferably, the weight ratio of the lowly graphitized material to the highly graphitized material is 3:7.

In another aspect, the active materials of the positive electrode include at least one material selected from the group consisting of Lithium iron phosphate (LiFePO₄), Lithium iron silicate (Li₂FeSiO₄), Lithium iron sulfate (Li₂Fe₂(SO₄)₃), Lithium iron fluorosulfate (LiFeSO₄F), Lithium manganese phosphate (LiMnPO₄) Lithium iron manganese phosphate (LiFeₓMn₁₋ₓPO₄).

In another aspect, the active material of the positive electrode is LiFePO₄.

Other objectives, advantages and features of the present invention will be apparent from the following description referring to the attached drawings.

### BRIEF DESCRIPTION OF DRAWINGS

The present invention will be described via detailed illustration of four embodiments versus the prior art referring to the drawings wherein:

FIG. 1 is a chart of discharge curves of two conventional lithium ion batteries and discharge curves of lithium ion batteries according to the embodiments of the present invention;

FIG. 2 is a chart of the initial coulombic efficiency of the lithium ion battery versus the percentage of hard carbon in active materials of a negative electrode according to the present invention; and

FIG. 3 is a chart of the capacity of the lithium ion battery versus the percentage of hard carbon in the active materials of a negative electrode according to the present invention.

### DETAILED DESCRIPTION OF EMBODIMENTS

Two conventional lithium ion batteries will be described before four lithium ion batteries according to embodiments of the present invention. To make a positive electrode of the first conventional lithium ion battery, 24 g (grams) of polyvinylidene fluoride (PVDF) are added into 600 g of N-methyl pyrrolidinone (NMP). The polymer and the solvent are stirred in a high-speed blender for about 3 hours so that the polymer is completely dissolved in the solvent. Then, 8 g of super-p and 16 g of vapor growth carbon fiber (VGCF) are added into the solution and stirred so that they are evenly scattered. Subsequently, 352 g of LiFePO₄ powder are added into the mixture, stirred and completely scattered to make a positive paste. The positive paste is coated on both sides of an aluminum foil and dried to make the positive electrode.

### First Conventional Lithium Ion Battery

To make a negative electrode of the first conventional lithium ion battery, 10 g of polyvinylidene fluoride are added into 200 g of N-methyl pyrrolidinone. The polymer and the solvent are stirred in the high-speed blender for about 3 hours so that the polymer is completely dissolved in the solvent. Then, 4 g of super-p are added into the solution and stirred so that the super-p is evenly scattered in the solution. Subsequently, 186 g of graphite powder are added into the mixture, stirred and completely scattered to make a negative paste. The negative paste is coated on both sides of a copper foil and dried to make a positive electrode.

To make electrolyte of the first conventional lithium ion battery, there is provided solvent including ethylene carbonate (EC), ethyl methyl carbonate (EMC) and dimethyl carbonate (DMC) at a volume ratio of 3:3:4. Lithium hexafluorophosphate (LiPF₆) is dissolved in the solvent to make the electrolyte. The concentration of the salt is 1 mol/L.

The positive electrode, a separator and the negative electrode are stacked to make an electrode assembly. The separator is sandwiched between the positive and negative electrodes. The electrode assembly is located in a case. The electrolyte is filled in the case which will be sealed to make a battery.

### Second Conventional Lithium Ion Battery

The second conventional lithium ion battery is manufactured like the first conventional lithium ion battery except including 186 g of hard carbon instead of the 186 g of graphite.

### FIRST EMBODIMENT

The lithium ion battery according to the first embodiment of the present invention is manufactured like the first conventional lithium ion battery except including 18.6 g of hard carbon and 167.4 g of graphite instead of the 186 g of graphite. Hence, the weight percentage of the hard carbon in the active materials of the negative electrode is 10%.

### SECOND EMBODIMENT

The lithium ion battery according to the second embodiment of the present invention is manufactured like the first conventional lithium ion battery except including 55.8 g of hard carbon and 130.2 g of graphite instead of the 186 g of graphite. Hence, the weight percentage of the hard carbon in the active materials of the negative electrode is 30%.

THIRD EMBODIMENT

The lithium ion battery according to the third embodiment of the present invention is manufactured like the first conventional lithium ion battery except including 93 g of hard carbon and 93 g of graphite instead of the 186 g of graphite. Hence, the weight percentage of the hard carbon in the active materials of the negative electrode is 50%.

### FOURTH EMBODIMENT

The lithium ion battery according to the fourth embodiment of the present invention is manufactured like the first conventional lithium ion battery except including 148.8 g of hard carbon and 37.2 g of graphite instead of the 186 g of graphite. Hence, the weight percentage of the hard carbon in the active materials of the negative electrode is 80%.

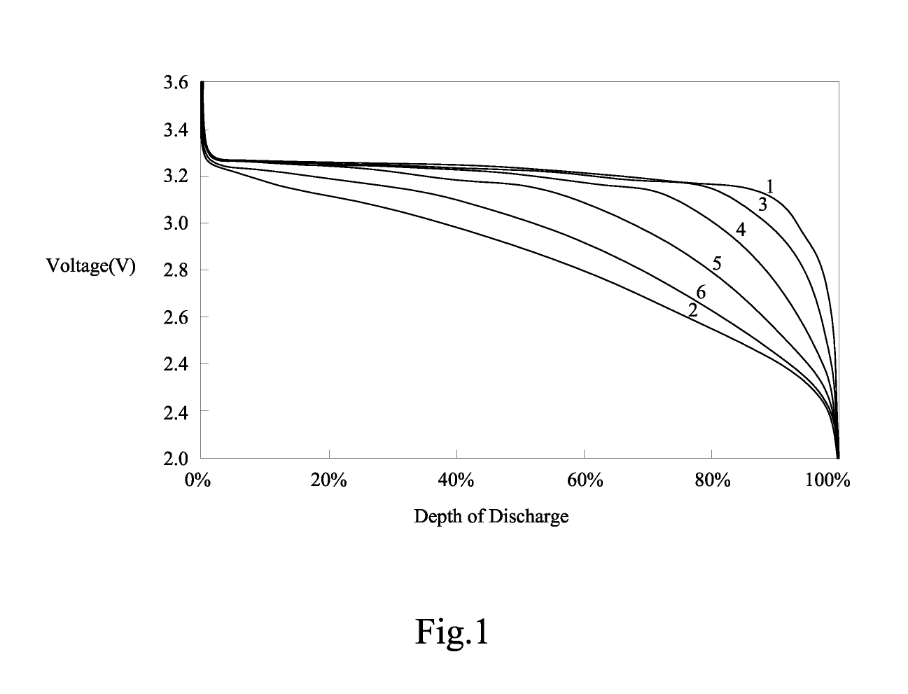

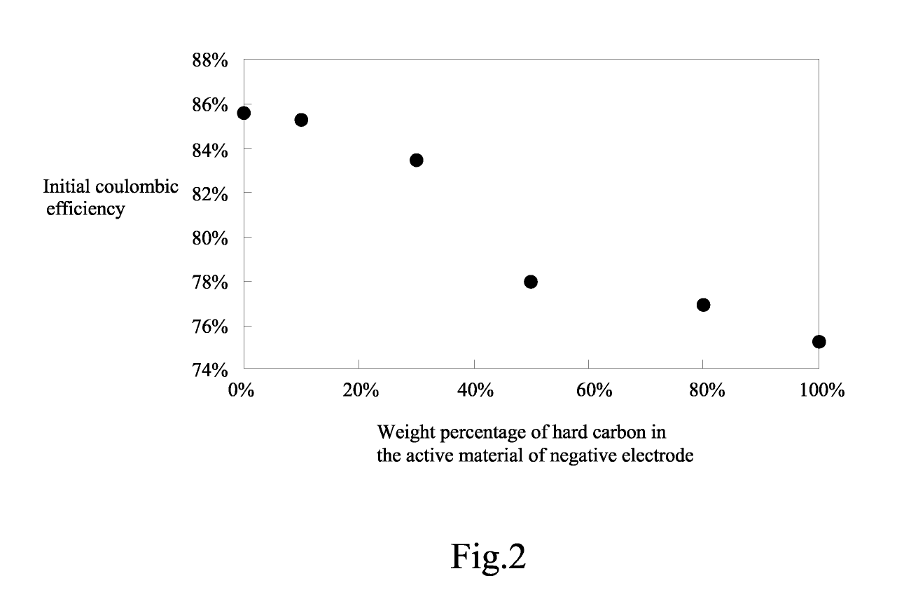

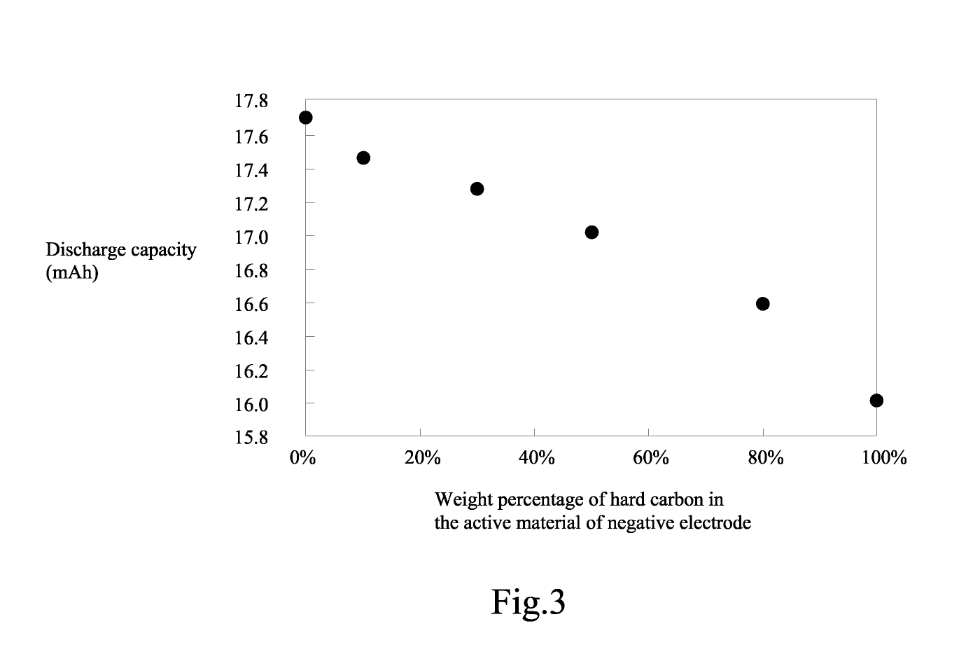

The conventional lithium ion batteries and the lithium ion batteries of the present invention are initialized by charging the battery to 3.65V with a current of 0.2 C and then discharging the battery to 2.0V with a current of 0.2 C. Initial coulombic efficiency and discharge capacity are measured and shown in FIGS. 2 and 3. Then, the lithium ion batteries are recharged to 3.65 volts, and discharged with a current of 0.2 C to 2.0 volts. Curves of the discharge voltage versus the DOD of the battery are shown in FIG. 1 wherein curve #1 represents the first conventional lithium ion battery, and curve #2 the lithium ion battery according to the first embodiment of the present invention, and curve #3 the lithium ion battery according to the second embodiment of the present invention, and curve #4 the lithium ion battery according to the third embodiment of the present invention, and curve #5 the lithium ion battery according to the fourth embodiment of the present invention, and curve #6 the second conventional lithium ion battery.

Referring to the curve #1 of FIG. 1, battery with LiFePO4 as the only active material of the positive electrode and graphite as the only active material of the negative electrode exhibits a flat discharge curve during most of the discharge. The discharge voltage drops just a little as the DOD increases.

It is difficult to indicate the DOD by the discharge voltage. Only after the DOD reaches 90%, the discharge voltage drops considerably, and only then it is possible to indicate the DOD by the discharge voltage. In practice, the DOD of 90% means that electricity left in the lithium ion battery is only 10% of the maximum capacity of the lithium ion battery. This is inadequate for the management of the lithium ion battery and too late to remind a user of recharging the lithium ion battery.

The battery with negative electrode that includes pure hard carbon as the only active material exhibits an inclined discharge curve during the entire discharge. The discharge voltage drops considerably as the DOD increases during the entire discharge. The DOD can precisely be indicated by the discharge voltage during the entire discharge.

The battery with negative electrodes that include graphite and hard carbon as the active materials exhibit discharge curves partly like the battery with negative electrode that includes hard carbon as the only active material and the battery of the negative electrode that includes graphite as the only active material. The battery with negative electrodes that include graphite and hard carbon as the active materials exhibit inclined discharge curves at least during the final phase of the discharge. Hence, the DOD of the battery can precisely be indicated by the discharge voltage at least during the final phase of the discharge.

As the ratio of hard carbon increases, the range of DOD that can precisely be indicated by the discharge voltage is enlarged. Where the weight ratio of the hard carbon in the active materials is 10%, after the DOD reaches 82%, the discharge voltage begins to drop considerably as the DOD increases. The range of DOD that can precisely be indicated by the discharge voltage is enlarged to 82% to 100%.

Where the weight ratio of the hard carbon in the active materials is 30%, the range of DOD that can precisely be indicated by the discharge voltage is enlarged to 82% to 100%. Where the weight ratio of the hard carbon in the active materials is 50%, the range of DOD that can precisely be indicated by the discharge voltage is 55% to 100%. Where the weight ratio of the hard carbon in the active materials is 80%, the range of DOD that can precisely be indicated by the discharge voltage is 35% to 100%.

However, a lithium ion battery that includes pure hard carbon as the negative active material exhibits a lower energy density than a lithium ion battery that includes pure graphite as the negative activate material does because of the low specific capacity, low electrode density and the low initial coulombic efficiency of hard carbon. Where both of graphite and hard carbon are used as the active materials, the hard carbon will still decrease the initial efficiency and the capacity delivering of the battery.

Referring to FIGS. 2 and 3, where graphite is used as the only active material, the initial coulombic efficiency is about 86%, and the capacity of the lithium ion battery is about 17.7 mAh. Where hard carbon is used as the only active material, the initial coulombic efficiency is about 75%, and the capacity of the lithium ion battery is about 16.0 mAh. Where both of graphite and hard carbon are used as the active materials, both of the initial coulombic efficiency and the capacity of the lithium ion battery are between those of the negative electrode that includes pure graphite and the negative electrode that includes pure hard carbon. The initial coulombic efficiency of the lithium ion battery drops and so does the reversible capacity of the lithium ion battery as the weight ratio of the hard carbon in the active materials increases.

Where the weight ratio of the hard carbon in the active materials is 10%, the initial coulombic efficiency is about 85%, and the capacity of the lithium ion battery is about 17.5 mAh. Where the weight ratio of the hard carbon in the active materials is 30%, the initial coulombic efficiency is about 83%, and the capacity of the lithium ion battery is about 17.3 mAh. Where the weight ratio of the hard carbon in the active materials is 50%, the initial coulombic efficiency is about 78%, and the capacity of the lithium ion battery is about 17.0 mAh. Where the weight ratio of the hard carbon in the active materials is 80%, the initial coulombic efficiency is about 77%, and the capacity of the lithium ion battery is about 16.6 mAh.

As discussed above, where a lithium ion battery includes both of graphite and hard carbon as the active materials of the negative electrode, the inclined discharge curve of the hard carbon increases the range of DOD that can be precisely indicated by the discharge voltage on one hand, and the high energy density of the graphite makes the lithium ion battery exhibit a high energy density on the other hand. For the indication of the DOD, it would be better to include more hard carbon. For higher energy density, it would be better to include more graphite.

In practice, the weight ratio of the hard carbon in the active materials of the negative electrode would better be 10% to 80% for precise indication of the DOD by the discharge voltage while exhibiting an adequate energy density. Preferably, the weight ratio of the hard carbon in the active materials of the negative electrode is 10% to 50% for precise indication of the DOD by the discharge voltage while exhibiting an adequate energy density. More preferably, the weight ratio of the hard carbon in the active materials of the negative electrode is 10% to 30% for precise indication of the DOD by the discharge voltage while exhibiting an adequate energy density. Most preferably, the weight ratio of the hard carbon in the active materials of the negative electrode is 30% for precise indication of the DOD by the discharge voltage without entailing a serious loss of energy density. In this case, the DOD can precisely be determined by the discharge voltage when the DOD is 70% to 100%.

Hard carbon is used to adjust the discharge curves in the embodiments to enlarge the range of the DOD that can be precisely indicated by the discharge voltage. Other lowly graphitized carbon such as soft carbon also exhibits a slopeing discharge curve and can enlarge the range of DOD indication, just like what the hard carbon do can however be used as hard carbon. Hence, the carbon can be replaced with other lowly graphitized carbon such as soft carbon or any combination of soft carbon with hard carbon.

Meanwhile, although graphite is included in the active materials of the negative electrode to exhibit high energy densities in the embodiments, other highly-graphitized carbon such as mesophase carbon bead and mesophase carbon fiber can also exhibit high energy densities and exhibit flat discharge curves. Hence, the graphite can be replaced with any other highly-graphitized carbon such as middle-phase carbon fibers and middle-phase carbon micro-balls, alone or in combination.

Hard carbon is like soft carbon regarding the discharge curve, the specific capacity and the coulomb efficiency. Various types of highly graphitized carbon are like one another regarding the discharge curve, the specific capacity and the coulombic efficiency. Therefore, the optimized hard carbon/graphite ratio is also applicable to the other lowly graphitized carbon/highly graphitized carbon negative electrode.

Meanwhile, LiFePO₄ is used in the embodiments to show that the negative electrode of the present invention can improve the range of DOD that can be indicated by the discharge voltage. However, other polyanion materials such as lithium manganese phosphate, and lithium iron fluorosulfate also exhibit flat discharge curves, and it is difficult to indicate the DOD by the discharge voltage if they are used in the positive electrode while pure graphite is used in the negative electrode. The use of lowly graphitized carbon combined with highly graphitized carbon in the negative electrode can be used to adjust the discharge curve of a lithium ion battery including any of these polyanionic materials in the positive electrode to enlarge the range of the DOD wherein the

DOD can be indicated by the discharge voltage. Hence, the materials of the positive electrode of the present invention can be other lithium ion and ions of transition metal polyanionic materials. The so-called polyanions include at least one of phosphate ion, silicate ion, sulfate ion and fluorosulfate ion. The so-called ions of the transition metal include the divalent ion of iron and the divalent ion of manganese.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A lithium ion battery including:
a negative electrode made of active materials including at least one lowly graphitized carbon material and at least one highly graphitized carbon material;
a positive electrode made of active materials including lithium ion and I, wherein the polyanion is selected from the group consisting of phosphate, silicate, sulfate and fluorosulfate, wherein the transition metal ion is selected from the group consisting of the divalent ions of iron and manganese;
a separator located between the electrodes; and
electrolyte for submerging the electrodes.

2. The lithium ion battery according to claim 1, wherein the lowly graphitized carbon material is selected from the group consisting of hard carbon, soft carbon and their combinations, wherein the highly graphitized material is selected from the group consisting of graphite, mesophase carbon bead, mesophase carbon fiber and their combinations.

3. The lithium ion battery according to claim 2, wherein the weight ratio of the lowly graphitized material to the highly graphitized material is 1:9 to 8:2.

4. The lithium ion battery according to claim 3, wherein the weight ratio of the lowly graphitized material to the highly graphitized material is 1:9 to 5:5.

5. The lithium ion battery according to claim 4, wherein the weight ratio of the lowly graphitized material to the highly graphitized material is 1:9 to 3:7.

6. The lithium ion battery according to claim 5, wherein the weight ratio of the lowly graphitized material to the highly graphitized material is 3:7.

7. The lithium ion battery according to claim 1, wherein the active materials of the positive electrode include at least one material selected from the group consisting of Lithium iron phosphate (LiFePO₄), Lithium iron silicate (Li₂FeSiO₄), Lithium iron sulfate (Li₂Fe₂(SO₄)₃), Lithium iron fluorosulfate (LiFeSO₄F), Lithium manganese phosphate (LiMnPO₄) Lithium iron manganese phosphate (LiFeₓMn₁₋ₓPO₄, 0<x<1).

8. The lithium ion battery according to claim 1, wherein the active material of the positive electrode is LiFePO₄.
